(19) United States
(12) Patent Application Publication
(10) Pub. No.: US 2017/0262627 A1
(43) Pub. Date: Sep. 14, 2017

(54) SITUATIONAL AWARENESS BASED LOGIN APPARATUS AND METHOD

(71) Applicant: ELECTRONICS AND TELECOMMUNICATIONS RESEARCH INSTITUTE, Daejeon (KR)

(72) Inventor: Jung Ho MYUNG, Daejeon-si (KR)

(21) Appl. No.: 15/235,657

(22) Filed: Aug. 12, 2016

(30) Foreign Application Priority Data
Mar. 10, 2016 (KR) 10-2016-0029077

(51) Int. Cl. G06F 21/45

(52) U.S. Cl. CPC G06F 21/45

(57) ABSTRACT

A situational awareness based login apparatus and method. The situational awareness based login apparatus includes a situation information collecting unit configured to collect situation information around a device, a situational awareness processing unit configured to identify and store a user from the collected situation information, and a device authenticating unit configured to compare the situation information and pre-stored device operation policy information and calculate a satisfaction rate, and configured to provide different login processes based on the calculated satisfaction rate.

### CROSS-REFERENCE TO RELATED APPLICATION(S)

This application claims priority to Korean Patent Application No. 10-2016-0029077, filed Mar. 10, 2016, in the Korean Intellectual Property Office, the disclosure of which is incorporated herein by reference in its entirety.

### BACKGROUND

1. Field

The following description relates to an apparatus security system, and more particularly, to a situational awareness based login apparatus.

2. Description of Related Art

As the Internet has developed and smart devices have spread, a user has been provided with various services including content and financial services by smart devices or mobile devices. The various services provided to the user require a security process for user identification and authentication. In a widely used method as a security process for using services, a login comprising an access identity (ID) and a password has been used.

In a conventional device such as a smart phone and a personal computer (PC), a login process has been conducted by inputting an ID and a password to access a specific server. A user has performed the login process by inputting his or her ID and password every login time or by a simplified way through an automatic login function in which the ID and password are saved. Functions including ID saving and automatic login can simplify the login process and provide user convenience, but can make serious security problems including an allowance of an inappropriate user or ID information exposure.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description relates to a situational awareness based login apparatus and method capable of solving a problem of information exposure by tightening system security, and capable of providing user convenience through a simplification of a login process.

In one general aspect, a situational awareness based login apparatus includes a situation information collecting unit configured to collect situation information around a device, a situational awareness processing unit configured to identify and store a user from the collected situation information, and a device authenticating unit configured to compare the situation information and pre-stored device operation policy information and calculate a satisfaction rate, and configured to provide different login processes based on the calculated satisfaction rate.

The situation information collecting unit may collect the situation information within a preset situational awareness range, and the situation information may include at least one of an accessing history of a wireless local area network, image information, and user position information.

The device authenticating unit may compare the situation information and the pre-stored device operation policy information and calculate the number of items which satisfy an item of the device operation policy information among items of the situation information as the satisfaction rate. Here, the device authenticating unit may provide login processes having different security grades based on the number of satisfied items of the device operation policy information or a preset condition.

The device operation policy information may include at least one of a user identity, an allowed access time, an allowed access place, age, sex, and weight as a factor capable of indicating a uniqueness of the user.

In another aspect, a situational awareness based login method includes collecting situation information around a device, identifying and storing a user from the collected situation information, comparing the situation information and pre-stored device operation policy information and calculating a satisfaction rate, and providing different login processes based on the calculated satisfaction rate. The collecting of the situation information around a device may include collecting the situation information within a predetermined situational awareness range.

The calculating of the satisfaction rate may include comparing the situation information and the pre-stored device operation policy information and calculating the number of items which satisfy an item of the device operation policy information among items of the situation information as the satisfaction rate. Further, the providing of the different login processes may include providing login processes having different security grades according to an achieved satisfaction rate based on the satisfaction rate which is based on a comparison result of the situation information and the pre-stored device operation policy information.

### BRIEF DESCRIPTION OF THE DRAWINGS

FIG. 1 is a diagram illustrating a situational awareness based login apparatus 100 according to one embodiment of the present invention.

FIG. 2 is a flowchart illustrating a service process of the situational awareness based login apparatus 100 according to one embodiment of the present invention.

FIGS. 3A and 3B are diagrams illustrating examples of login operations of the situational awareness based login apparatus 100 according to one embodiment of the present invention.

FIG. 4 is a diagram illustrating situation information storage and a management process by a situation information collecting unit 110 of the situational awareness based login apparatus 100 according to one embodiment of the present invention.

FIG. 5 is a diagram illustrating a process of extracting user information by a situational awareness processing unit 120 of the situational awareness based login apparatus 100 according to one embodiment of the present invention.

FIG. 6 is a diagram illustrating a process of checking a satisfaction rate by a device authenticating unit 130 of the situational awareness based login apparatus 100 according to one embodiment of the present invention.

FIGS. 7A to 7C are diagrams illustrating conditions of a satisfaction rate of the device authenticating unit 130 of the situational awareness based login apparatus 100 according to one embodiment of the present invention.

FIG. 8 is a flowchart illustrating another example of a service process of the situational awareness based login apparatus 100 according to one embodiment of the present invention.

FIG. 9 is a flowchart illustrating a situational awareness based login method according to one embodiment of the present invention.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be proposed to those of ordinary skill in the art. Also, descriptions of well-known functions and constructions may be omitted for increased clarity and conciseness.

Hereinafter, embodiments of the present invention will be described in detail with reference to the attached drawings. Terms and words described below are terminologies defined considering a function in the present invention, and these may be different according to the intention of the invention, custom, etc. Therefore, when specifically defined in the specification, terminologies used in the embodiments described below will follow such a definition. Unless otherwise defined, all terms used herein have the same meaning as commonly understood by one of ordinary skill in the art to which this inventive concept belongs.

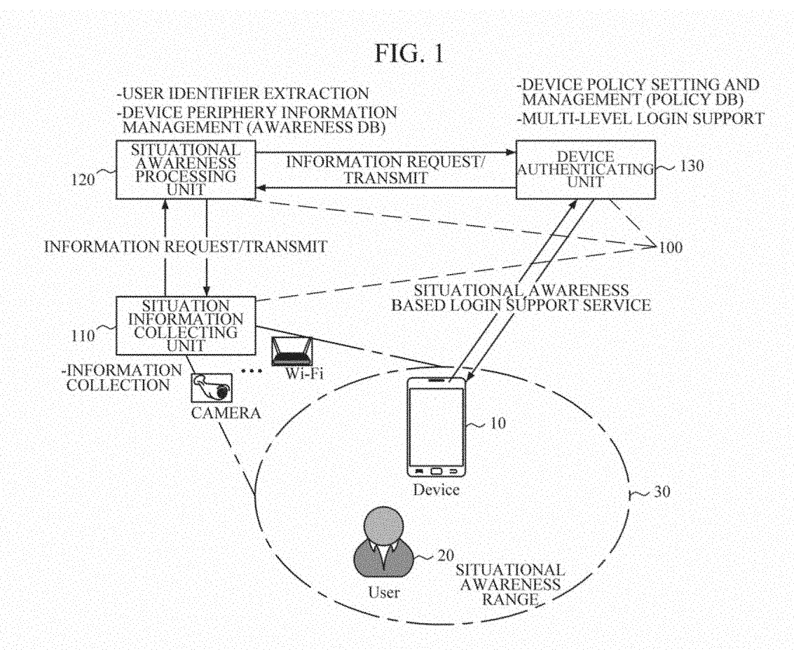

FIG. 1 is a diagram illustrating a situational awareness based login apparatus 100 according to one embodiment of the present invention.

Referring to FIG. 1, the situational awareness based login apparatus 100 according to one embodiment of the present invention may include a situation information collecting unit 110, a situational awareness processing unit 120, and a device authenticating unit 130. A user 20 refers to a user who uses a login service through a device 10, and, in the present invention, the user may be divided into a preregistered user and a nonregistered user in the device authenticating unit 130. The device 10 refers to a preregistered device in a situational awareness based login service, which is to access a corresponding server.

The situation information collecting unit 110 collects situation information around the device 10 which the user 20 holds. The situation information may include image information around the device 10, and user information and user position information which employ an accessing history of a wireless local area network (WLAN) such as Wi-Fi. Further, the situation information may include information on various situations around the device 10 such as a temperature change and a humidity change.

The situation information collecting unit 110 may collect situation information using various information collecting tools provided. Here, the situation information collecting unit 110 collects situation information within a situational awareness range 30 preset based on the device 10.

The situation information collecting unit 110 may film and collect image information around the device 10 using an image filming device (a camera) installed in the device 10.

Further, the situation information collecting unit 110 may collect user information employing an accessing history of the device 10 through the WLAN such as Wi-Fi. The situation information collecting unit 110 may collect information on an accessing position of the device 10 through the accessing history of the device 10 to the Wi-Fi.

The situation information collecting unit 110 may collect position information of all users 20 positioned within the situational awareness range 30. The situation information collecting unit 110 may collect position information not of the device 10 but of the user 20. The situation information collecting unit 110 may collect position information through position information of another device which the user 20 holds rather than the device 10. For example, the situation information collecting unit 110 may collect position information of the user 20 through a wearable device. The situation information collecting unit 110 may receive position information from a smart band which the user 20 wears, and collect the position information as user position information.

The situation information collecting unit 110 may collect situation information based on the preset situational awareness range 30 in the process of collecting situation information. The situation information collecting unit 110 may collect user access information such as a Wi-Fi sharer and a Bluetooth apparatus positioned within the situational awareness range 30.

The situation information collecting unit 110 stores and manages the collected situation information together with a device identity (ID) which is identification information. The situation information collecting unit 110 may manage the situation information based mainly on the device ID, and the situation information may be managed as the situational awareness range 30. An intrinsic ID which may identify a device including a media access control (MAC) address and identifier data of the user may be used as the device ID, and an ID value may be changed according to settings.

When the situation information collecting unit 110 collects situation information from devices within the situational awareness range 30, the situation information collecting unit 110 may collect situation information with a device ID from each device and manage the situation information. Further, the situation information collecting unit 110 may manage the situation information based on the situational awareness range 30 not based on the device 10. When managing based on the situational awareness range 30, the situation information collecting unit 110 may determine a specific identifier identifying each situational awareness range 30, and store and manage information.

The situational awareness processing unit 120 identifies a user for the collected situation information and stores the user. The situational awareness processing unit 120 may identify and store a user most frequently extracted from user information extracted from the situation information as a user of corresponding situation information, and may identify and store the user 20 nearest to the device 10 as the user of the corresponding situation information. A position of the user 20 may be known through a smart band or Bluetooth apparatus.

The situational awareness processing unit 120 collects and analyzes the situation information around the device 10 received from the situation information collecting unit 110, analyzes user identification information and which user is near the corresponding device 10, and stores and manages the situation information in an awareness database (DB) according to the analyzed user information.

The situation information collecting unit 110 collects situation information within the situational awareness range 30. Therefore, the collected situation information may be collected from multiple devices. Therefore, the situational awareness processing unit 120 extracts user information from the situation information, determines a user most frequently extracted based on the extracted user information, and stores the situation information with the determined user as a user ID. However, when a large error exists in a process of extracting a user from each situation, a system may give weight to specific situation information or determine the user based on the specific situation information.

The device authenticating unit 130 compares the determined situation information with preset device operation policy information. To this end, the device authenticating unit 130 checks how much the information on the determined user satisfies the preset device operation policy information by item.

Further, the device authenticating unit 130 compares the determined situation information with the device operation policy information and calculates a satisfaction rate. The device authenticating unit 130 may calculate the satisfaction rate based on the number of items of the device operation policy information which satisfied a condition, whether a specific condition is satisfied, and whether a specific condition or other conditions are satisfied. A satisfaction rate calculation condition of the device authenticating unit 130 may be determined by a manager who operates a service.

The device authenticating unit 130 compares the determined situation information with the device operation policy information (a policy DB), and performs login processes having different security grades based on the calculated satisfaction rate. The device authenticating unit 130 classifies login grades according to an achieved satisfaction rate based on the satisfaction rate, and assigns different login processes to the classified login grades. For example, when a high satisfaction rate is achieved, the device authenticating unit 130 performs a relatively simplified login process, and when a low satisfaction rate is achieved, the device authenticating unit 130 performs a relatively complicated login process.

The situational awareness based login apparatus 100 shown in FIG. 1 may be implemented as a separate independent apparatus, or may have a shape to be installed in the device 10 or in a separate smart device. Further, the situation information collecting unit 110, the situational awareness processing unit 120, and the device authenticating unit 130 included in the situational awareness based login apparatus 100 may be implemented as different apparatuses from each other instead of one apparatus, and particularly the situational awareness processing unit 120 and the device authenticating unit 130 may be implemented in a separate independent server form.

In FIG. 1, concepts with respect to components of the situational awareness based login apparatus 100 according to one embodiment of the present invention were described, and more specific content will be additionally described with reference to drawings shown below.

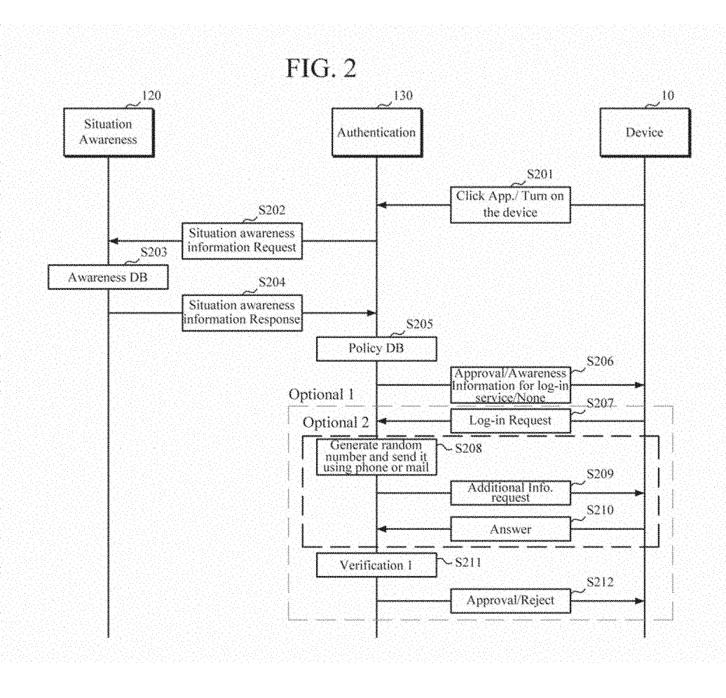

FIG. 2 is a flowchart illustrating a service process of the situational awareness based login apparatus 100 according to one embodiment of the present invention.

Referring to FIGS. 1 and 2, the service of the situational awareness based login apparatus 100 according to one embodiment of the present invention, first, when events including powering on of the device 10 or executing an application for server access occur, service request information corresponding to the occurred event is transferred from the device 10 to the device authenticating unit 130 (S201).

The device authenticating unit 130 identifies the device 10 which request the service, and requests situation information on the identified device from the situational awareness processing unit 120 (S202). When the service request information is received, the device authenticating unit 130 requests information for identifying the device 10 which requested the service (e.g., identification by MAC address) from the situational awareness processing unit 120 before the service is provided to the corresponding device 10.

When a situation information request is received from the device authenticating unit 130, the situational awareness processing unit 120 retrieves situation information (a user ID, a place, etc.) corresponding to the requested device using a DB composed of situation information received from the situation information collecting unit 110 (S203). User information of the most frequently extracted user is selected as a user of the corresponding situation information. The device authenticating unit 130 retrieves situation information corresponding to the requested device from a DB composed of the previously extracted user information. When the user is not registered, a user ID space may be filled with a vacant space (null or the like) or pre-appointment information (guest or the like). Further, a DB established for ease of management may be omitted. The situational awareness processing unit 120 transmits the situation information (the user information) retrieved from the DB to the device authenticating unit 130 (S204).

The device authenticating unit 130 retrieves an operation policy DB (a policy DB) of the device based on the received situation information (S205). Here, operation policy information composing the operation policy DB is previously defined and is information which the manager inputs. For example, all factors capable of indicating a uniqueness of the user including a user ID, an allowed access time, an allowed access place, age, sex, and weight may be used as the operation policy information, and an additional expansion of factors is possible.

Next, the device authenticating unit 130 compares the number of satisfied factors (a satisfaction rate) of the total number N of factors defined by the operation policy information to the total number of factors, and determines a login process (S206). The device authenticating unit 130 identifies the number of factors (the satisfaction rate) satisfying the number of the defined factors, compares this with a satisfaction rate condition of the operation policy information, and provides a login method in which different security grades are considered.

TABLE 1
An example of various login methods

| | | |
|---|---|---|
| login 1 | when T₁ or more (T₁ ≦ N) is satisfied | automatic login |
| login 2 | when T₂ or more (T₂ ≦ T₁) is satisfied | simplified login |
| | and information helpful for login exists | |
| login 3 | when T₃ or more (T₃ ≦ T₂) is satisfied, | general login |
| | and information helpful for login does | |
| | not exist | |
| login 4 | when T₄ or more (T₄ ≦ T₃) is satisfied, | complicated login |
| | and information helpful for login does | |
| | not exist | |
| login 5 | when less than T₄ is satisfied | login impossible |

Table 1 shows an example of various login methods selected by the device authenticating unit 130. In Table 1, N denotes the total number of factors, and T1 to T4 denote satisfaction rate conditions (satisfaction rate threshold values). In Table 1, login processes having different security grades may be provided according to the number of factors which achieved the satisfaction rate among all factors by comparing the operation policy information and the satisfaction rate.

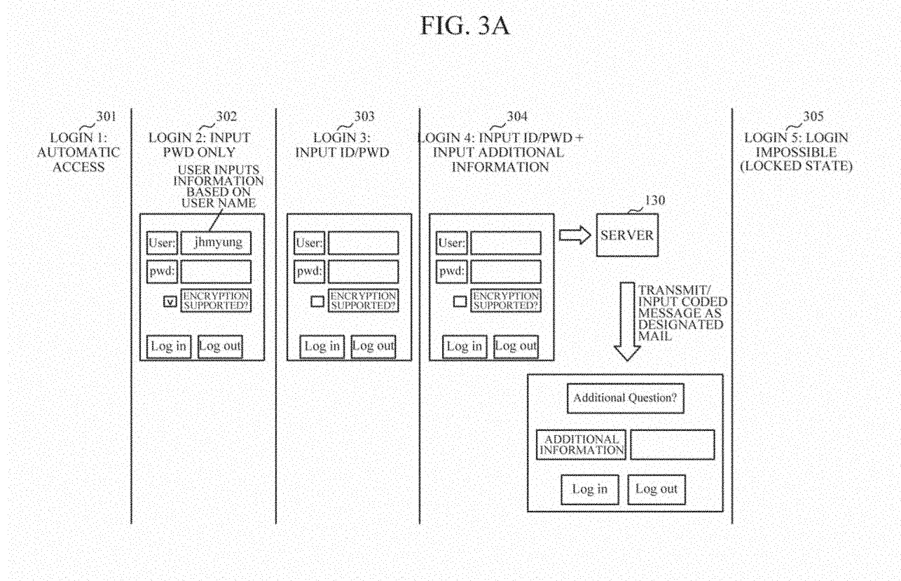

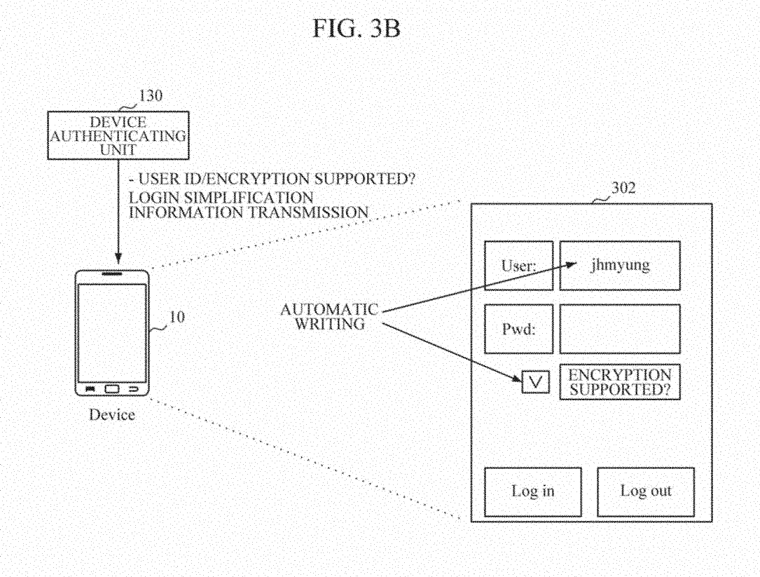

In the example of Table 1, login 1 is a case in which the highest satisfaction rate condition is achieved and provides an automatic login function without an additional login process. Further, login 2 is a case in which the second highest satisfaction rate condition is achieved and provides a simplified login. Further, according to an achievement of the satisfaction rate condition, higher security processes may be executed by applying each of login 3, login 4, and login 5. A login method according to the example of Table 1 will be described with an example shown in FIG. 3B.

The above described information helping login may include image information, Bluetooth device information, mobile phone device information, Wi-Fi access information, and a recognizer.

Image information is information in which an ID is extracted through user image analysis in an imaging camera around the device. Bluetooth device information is information in which an ID is extracted by comparing a name (e.g., Bob's apple watch) and a MAC address (e.g., AA:BB:CC:DD:EE:FF) of a Bluetooth apparatus such as a smart band and a smart watch with a preregistered value.

Mobile phone device information is information in which user information is extracted through mobile phone information (using mobile phone tracking information). Wi-Fi access information is information in which a user ID is extracted through a MAC address of Wi-Fi terminal B used by a user who accesses a Wi-Fi sharer positioned on device A space to be accessed. The recognizer (a card recognizer, an iris recognizer, etc.) refers to a use of an employee ID card tag for entering a locked controlled space and user information for entering the controlled space using iris information.

The above described parameters N and T may be variously changed according to operation policy settings. In addition, a login operation mapped to a corresponding condition may also be variously changed according to the operation policy settings.

When a login operation determined by the device authenticating unit 130 is not an automatic login operation, the device 10 supplements additional login information from the user and requests a login from the device authenticating unit 130 (S207). When the login operation is not the automatic login operation, as the example shown in Table 1, the device authenticating unit 130 requests additional information corresponding to login 2 through login 4 from the device 10, and the user inputs information according to an additional login process and requests a login from the device authenticating unit 130.

Next, the device authenticating unit 130 generates additional identification information (S208) and transmits the additional identification information to the device 10 (S209). For example, a random number or the like may be applied as the additional identification information. Further, the device authenticating unit 130 may transmit the additional identification information to the device 10 in a form of an email or text message. The additional identification information is transmitted to the user 20 through the device 10, and the user 20 inputs the additional identification information through the device 10 and transmits the additional identification information to the device authenticating unit 130 (S210). Further, when the additional identification information is received, the device authenticating unit 130 verifies the received information (S211) and determines whether the device 10 accesses a server (S212).

In an example of FIG. 2, according to a determination of a login operation in operations S205 and S206, operations S207 to S212 may be selectively performed.

FIGS. 3A and 3B are diagrams illustrating examples of login operations of the situational awareness based login apparatus 100 according to one embodiment of the present invention.

Referring to FIGS. 3A and 3B, the situational awareness based login apparatus 100 compares the number of satisfied factors (satisfaction rate) of the total number N of factors defined by the operation policy information and determines the login process.

In Table 1 shown above, login operations are divided in five operations from login 1 to login 5, and different login processes may be performed. When the determined login operation is login 1 (S301), the situational awareness based login apparatus 100 determines that the corresponding device 10 has a high security grade and allows an automatic access (automatic login).

When the determined login operation is login 2 (S302), the situational awareness based login apparatus 100 requests a simplified login method to the device 10. As shown in FIG. 3B, the simplified login is a login method in which the user ID is transmitted from the device authenticating unit 130 to the device 10 and a user ID is automatically written, but a password is not automatically input, and therefore the password is specially input. When the login is performed through the simplified login, and when the user accesses the device authenticating unit 130, and when various pieces of information needed for identification including ID information, information on whether encryption is supported, age, and sex, etc. are to be input, information corresponding to that is transmitted to the device 10 and the login simplification may be supported.

When the determined login operation is login 3 (S303), the situational awareness based login apparatus 100 requests a general login method to the device 10. The general login method is a login method which requires ID input and a password input.

When the determined login operation is login 4 (S304), the situational awareness based login apparatus 100 requests a complicated login method to the device 10. The complicated login method is a login method in which additional information is required in addition to ID and a password. For example, the device authenticating unit 130 may transmit an identification number in a form of email or text message, and the user may additionally input the received identification number to the device 10. On the other hand, when factors of the operation policy are satisfied below a criterion, the situational awareness based login apparatus 100 may make the login of the corresponding device 10 impossible.

In the examples of login methods shown in FIGS. 3A and 3B, a criterion, a method, and the number of operations of login operations are not limited. The login process and the login method may be variously set based on operation policy settings.

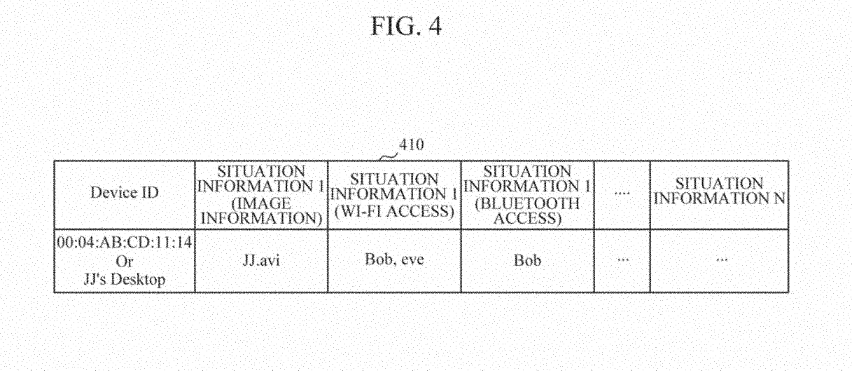

FIG. 4 is a diagram illustrating situation information storage and a management process by a situation information collecting unit 110 of the situational awareness based login apparatus 100 according to one embodiment of the present invention.

Referring to FIGS. 1 and 4, the situation information collecting unit 110 may collect situation information within the situational awareness range 30 around the device 10 which the user 20 holds. The situation information collecting unit 110 stores and manages the situation information using various devices (an image filming device, a Wi-Fi sharer, a Bluetooth device) positioned around the device 10 (a situational awareness range) which supports a situational awareness based login service.

The situation information may be managed based mainly on the device ID, and the situation information may be managed according to the situational awareness range 30. When situation information is managed based mainly on the device ID, an intrinsic ID which may identify devices including a MAC address and identifier data of the user may be used as the device ID.

The situation information may include image information acquired through an image filming device, user access information of a Wi-Fi sharer positioned within the situational awareness range 30 around the corresponding device 10, access information of a Bluetooth apparatus, and the like, and all information helpful for finding potential users or over a preset number of pieces of such information may be included in the situation information.

When the situation information is managed according to the situational awareness range instead of a device, a separate identifier which identifies each situational awareness range may be provided, and information may be stored and managed in the same way as described above. A situation information table 410 of FIG. 4 describes an example in which a total number of pieces n of collected situation information is divided by device ID and stored.

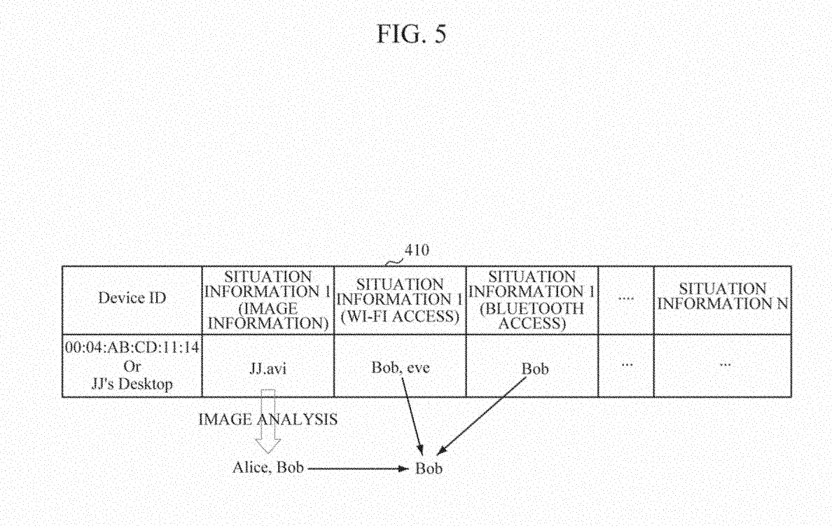

FIG. 5 is a diagram illustrating a process of extracting user information by the situational awareness processing unit 120 of the situational awareness based login apparatus 100 according to one embodiment of the present invention.

Referring to FIGS. 4 and 5, the situational awareness processing unit 120 extracts user information corresponding to respective situation information based on the collected situation information, and selects most frequently extracted user information based on the extracted user information. However, when a large error exists in a process of extracting a user from each situation, a system may give weight to specific situation information or determine the user based on the specific situation information.

The situational awareness processing unit 120 extracts the user information from the situation information table 410. As shown in FIG. 5, the situational awareness processing unit 120 may extract “Alice” through image analysis from situation information 1 of the situation information table 410, and may extract “Bob” from situation information 2 and situation information 3. Here, the situational awareness processing unit 120 may select “Bob” which is extracted most frequently as the user information. Through the process described above, selected user information is determined as the user in corresponding situation information.

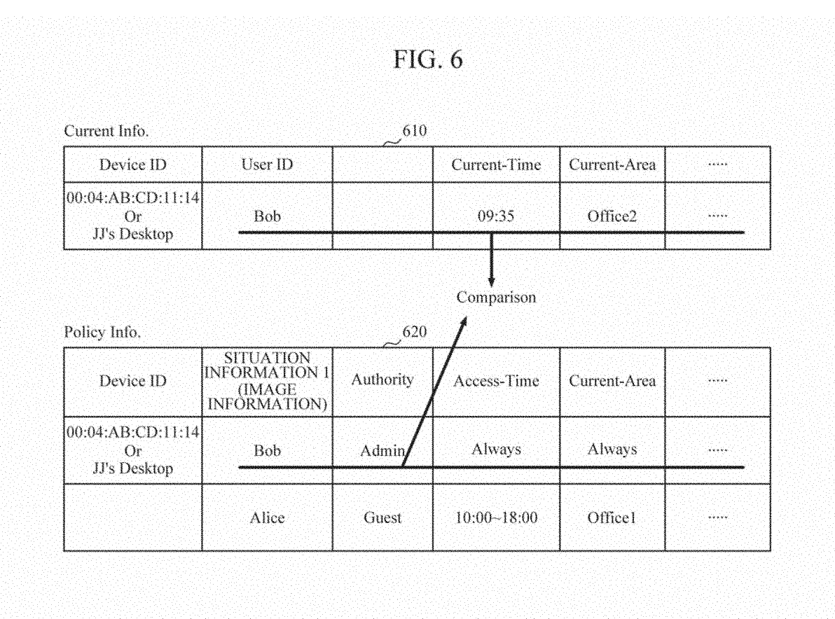

FIG. 6 is a diagram illustrating a process of checking a satisfaction rate by the device authenticating unit 130 of the situational awareness based login apparatus 100 according to one embodiment of the present invention.

Referring to FIG. 6, the device authenticating unit 130 compares situation information 610 determined by the situational awareness processing unit 120 based on predetermined device operation policy information 620 and estimates a satisfaction rate. The device authenticating unit 130 compares an item of the determined situation information 610 and an item of the device operation policy information 620 and estimates the satisfaction rate through the number of identical items which appear.

In the method of calculating a satisfaction rate of the present invention, the satisfaction rate may be calculated by considering how many items among all of the items are satisfied, whether a specific condition is satisfied, and how many other conditions are satisfied when the specific condition is satisfied.

The device authenticating unit 130 determines a login operation of the situation information through a satisfaction rate threshold value (hereinafter, a threshold value) of the preset device operation policy information 620. As shown in FIGS. 3A and 3B, when the satisfaction rate is a determined arbitrary threshold value 1 T1 or more, login 1 is supported, when the satisfaction rate is less than the threshold value 1 and a threshold value 2 or more and information helpful for login exists, login 2 is supported. Further, login 3 to login 5 are supported according to the remaining threshold value conditions.

Here, the device authenticating unit 130 may compose the device operation policy information 620 with only some of the threshold values instead of applying all of the threshold values. For example, when the threshold value 1 is not used, the automatic login process may be omitted.

TABLE 2
An example of threshold values of device operation policy information

| | |
|---|---|
| satisfaction rate = 100% | login 1 |
| 100% > satisfaction rate ≧ 80% | login 2 |
| 80% > satisfaction rate ≧ 60% | login 3 |
| 60% > satisfaction rate ≧ 40% | login 4 |
| 40% > satisfaction rate | login 5 |

For example, the device authenticating unit 130 may set the threshold value as 100%, 80%, 60%, 40%, and 0%. When all the conditions are 100% satisfied, login 1 may be supported, and when the satisfaction rate is less than 100% and 80% or more, login 2 may be supported.

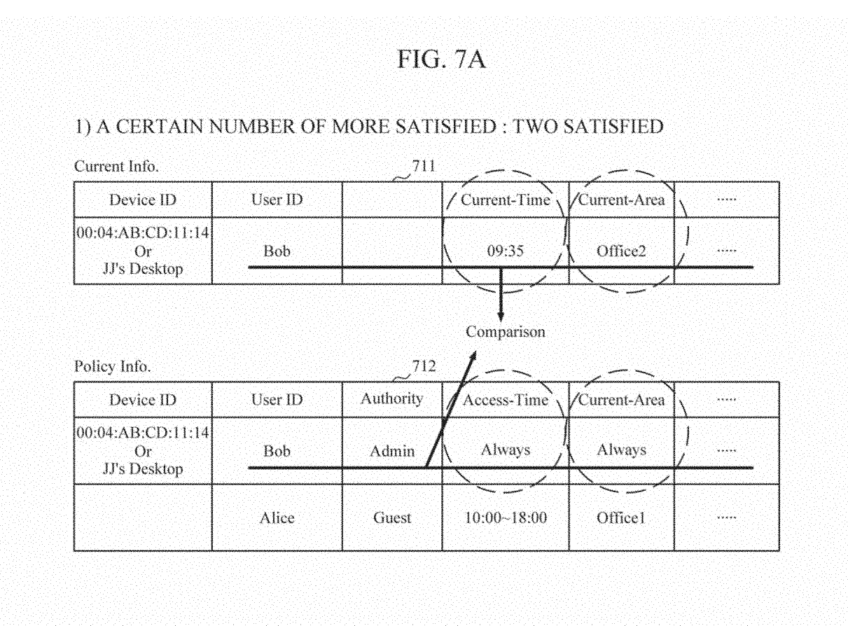

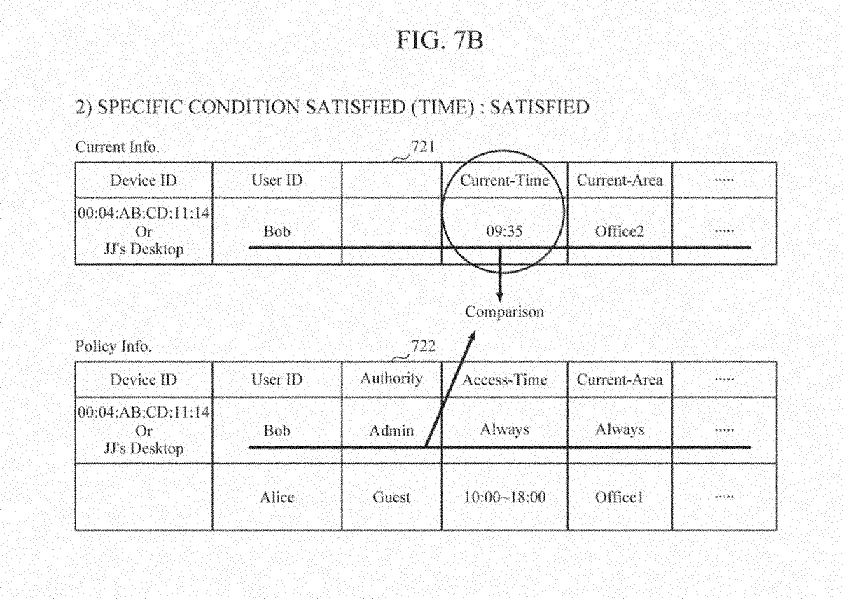

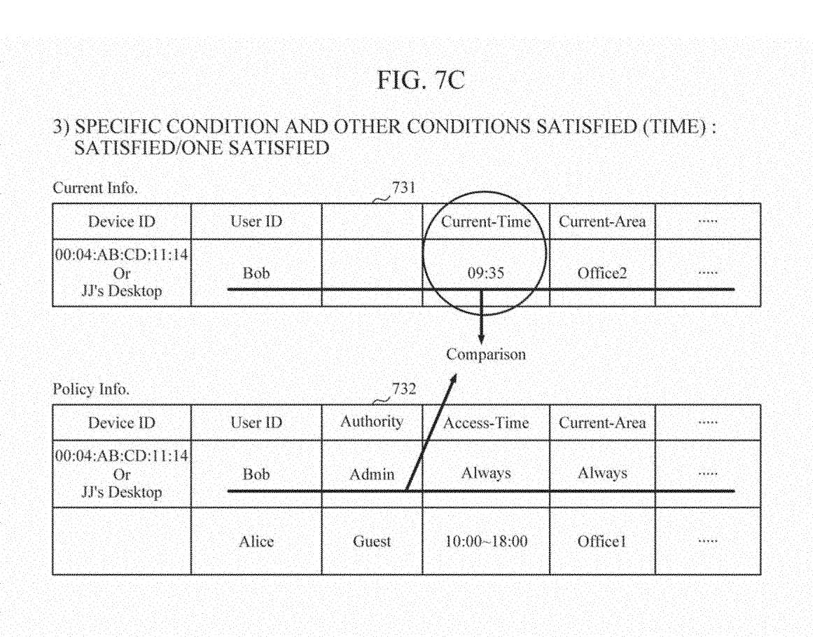

FIGS. 7A to 7C are diagrams illustrating satisfaction rate conditions of the device authenticating unit 130 of the situational awareness based login apparatus 100 according to one embodiment of the present invention.

Referring to FIGS. 7A to 7C, the satisfaction rate of the device authenticating unit 130 of the situational awareness based login apparatus 100 according to one embodiment of the present invention may be determined according to conditions. For example, the conditions of the satisfaction rate may be determined by threshold values and may be determined by a specific condition.

FIG. 7A shows a case in which items of the situation information and the operation policy information are compared and a threshold value of 2 or more is satisfied. In FIG. 7A, items of time and an area of situation information 711 are identical to those of operation policy information 712. A current time Current-Time of the situation information 711 is 09:35 and corresponds to “Always” of an access time Access-Time of the operation policy information 712. Further, the current area (Current-Area) of the situation information 711 is an office Office2 and corresponds to “Always” of the current area Current-Area of the operation policy information 712. Therefore, the situation information 711 satisfies a condition of 2 or more which is a threshold value, and may be supported by a login process corresponding to that condition.

FIG. 7B shows a case in which a specific condition is set as time and the specific condition is satisfied. In situation information 721 of FIG. 7B, the item of current time Current-Time is 09:35 and corresponds to “Always” of the access time Access-Time of operation policy information 722. Therefore, the corresponding situation information 721 satisfies the specific condition and may be supported by a login process corresponding to that specific condition.

FIG. 7C shows a case in which a specific condition is satisfied at the same time as another condition. For example, the set specific condition is an item of time, and another condition may be set so that 1 or more items are additionally satisfied. In situation information 731 of FIG. 7C, the item of current time (Current-Time) is 09:35 and corresponds to “Always” of the access time Access-Time of operation policy information 732. Further, the current area Current-Area of the situation information 731 is an office Office2 and corresponds to “Always” of the current area Current-Area of the operation policy information 732. Therefore, the situation information 731 satisfies the time which is the specific condition and satisfies the additional condition in which 1 or more items are satisfied and may be supported by the corresponding login process.

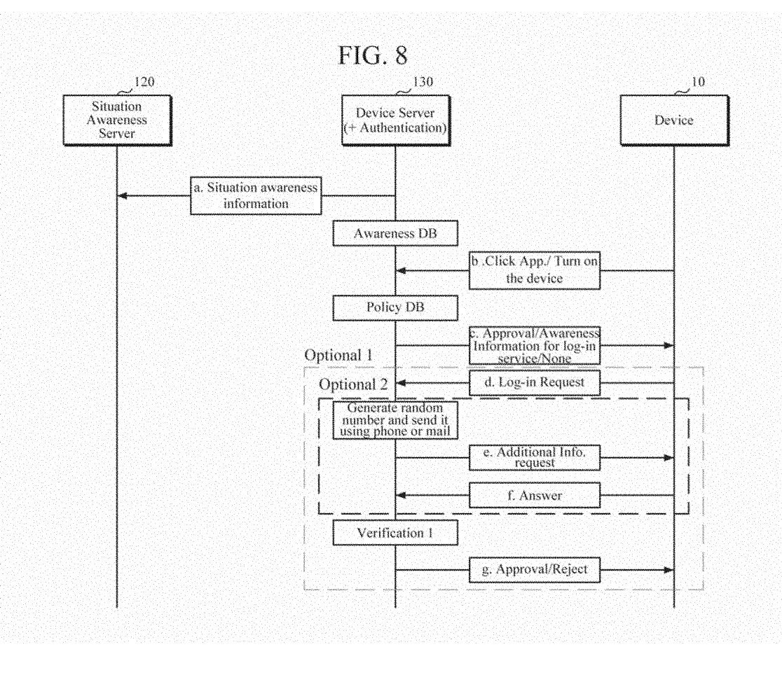

FIG. 8 is a flowchart illustrating another example of a service process of the situational awareness based login apparatus 100 according to one embodiment of the present invention.

Referring to FIGS. 2 and 8, the situational awareness based login apparatus 100 according to one embodiment of the present invention may perform a service process different from that of FIG. 2. In the service process of FIG. 8, an awareness DB is previously established in the device authenticating unit 130 unlike in FIG. 2. Such a difference in an implementation of the method may cause differences in a position of the awareness DB or an establishing time. However, from the viewpoint that situation information is employed in the login service, the service processes of FIGS. 2 and 8 may be considered to be the same. When a situational awareness based login service shown in FIG. 8 is used, diversification of a login system may be achieved by applying techniques of an automatic login, a simplified login, a general login, and an enhanced login according to settings based on a situational awareness result.

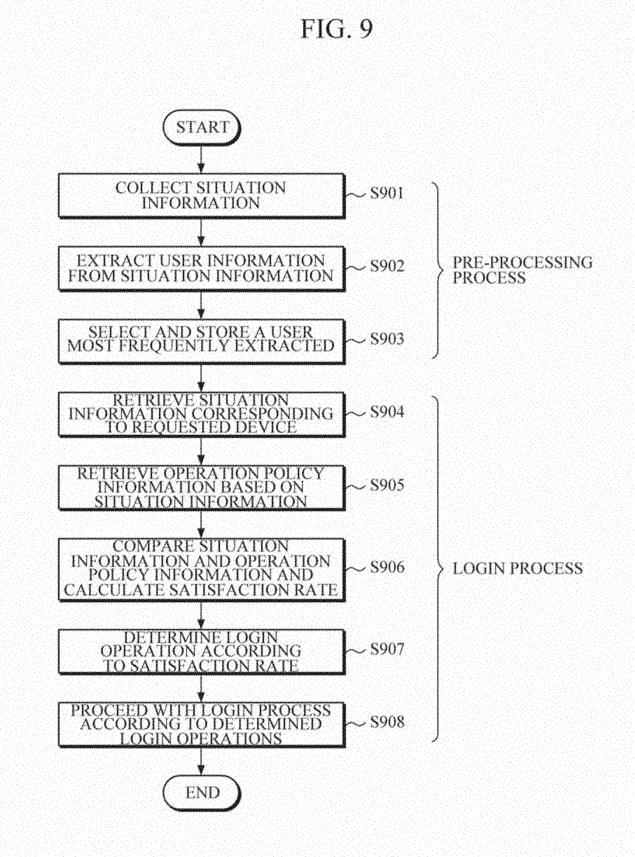

FIG. 9 is a flowchart illustrating a situational awareness based login method according to one embodiment of the present invention.

Referring to FIG. 9, the situational awareness based login method according to one embodiment of the present invention may be roughly divided into a pre-processing process and a login process. The pre-processing process is a process performed before the login process and is a process in which situation information is collected and managed.

First, a situational awareness based login apparatus collects situation information around a device based on a situational awareness range (S901). The situation information may include image information around a device, user information and user position information which employ an accessing history of a WLAN such as Wi-Fi. Further, the situational awareness based login apparatus extracts user information from the collected situation information (S902) and selects and stores a user most frequently extracted from the extracted user information (S903). By repeatedly performing this process, the situational awareness based login apparatus divided by user may establish a situation information DB.

After the situation information DB is established by repeatedly performing operations S901 to S903, a login process is performed according to operations S904 to S908.

First, when a service request is received from the device, the situational awareness based login apparatus retrieves situation information corresponding to the requested device in the situation information DB (S904). Further, the situational awareness based login apparatus retrieves an operation policy DB (a policy DB) of the device based on the received situation information (S905). Here, operation policy information composing the operation policy DB is predefined and is information which a manager inputs. For example, all factors capable of indicating a uniqueness of a user including a user ID, an allowed access time, an allowed access place, age, sex, and weight may be used as the operation policy information, and an additional expansion of factors is possible.

Next, the situational awareness based login apparatus compares the situation information and the operation policy information and calculates a satisfaction rate (S906). The situational awareness based login apparatus compares this with a satisfaction rate condition of the operation policy information, and provides a login method in which different security grades are considered. Further, the situational awareness based login apparatus determines a login operation according to the calculated satisfaction rate (S907). For example, the login operation may include various login operations from an automatic login operation in which a process is simplified and a simplified login operation to a complicated login operation in which a process is enhanced. For specific login operations and login methods refer to FIG. 2 above.

When the login operation is determined, the situational awareness based login apparatus progresses a login process according to the determined login operation (S908). For example, the login process may be omitted when the automatic login is used, and an additional login process such as an identification number may be performed when the complicated login is used.

The present invention including the above-described content may be implemented as a computer program. Codes and code segments constituting the computer program may be easily inferred by a skilled computer programmer in the art. Further, the computer program may be stored in a computer readable recording medium which is read out and executed by a computer so that the method of the present invention can be implemented. Further, the computer readable recording medium includes all types of recording media from which the computer may read out.

In comparison to a conventional login service based on ID and a password, the situational awareness based login apparatus and method can remove the inconvenience of inputting an ID and password for each login, and can provide a login service to a user when the user forgets his or her ID and password. Further, since the situational awareness based login apparatus and method uses situation information, a problem of security which a conventional automatic login serve has can be solved and a danger of ID theft can be decreased.

While a number of exemplary embodiments of the present invention have been described above, the present invention is not limited thereto and it should be understood that various modifications may be made as long as they fall within the range of the scope of the present invention described in the claims below.

What is claimed is:

1. A situational awareness based login system comprising:
a situation information collecting unit configured to collect situation information around a device;
a situational awareness processing unit configured to identify and store a user from the collected situation information; and
a device authenticating unit configured to compare the situation information and pre-stored device operation policy information and calculate a satisfaction rate, and configured to provide different login processes based on the calculated satisfaction rate.

2. The login system of claim 1, wherein the situation information collecting unit collects the situation information within a preset situational awareness range.

3. The login system of claim 1, wherein the situation information includes at least one of an accessing history of a wireless local area network, image information, and user position information.

4. The login system of claim 1, wherein the device authenticating unit compares the situation information and the pre-stored device operation policy information and calculates the number of items which satisfy an item of the device operation policy information among items of the situation information as the satisfaction rate.

5. The login system of claim 1, wherein the device authenticating unit determines login processes based on the number of satisfied items of the device operation policy information or a preset condition.

6. The login system of claim 1, wherein the device authenticating unit provides login processes having different security grades according to an achieved satisfaction rate based on the satisfaction rate which is based on a comparison result of the situation information and the pre-stored device operation policy information.

7. The login system of claim 1, wherein the device operation policy information includes a factor which indicates a uniqueness of the user.

8. The login system of claim 7, wherein the device operation policy information includes at least one of a user identity, an allowed access time, an allowed access place, age, sex, and weight.

9. The login system of claim 1, wherein the device authenticating unit i compares items of the situation information and items of the pre-stored device operation policy information and determines the satisfaction rate by whether a preset threshold value or more is satisfied.

10. The login system of claim 1, wherein the device authenticating unit compares items of the situation information and items of the pre-stored device operation policy information and determines the satisfaction rate by whether a specific item is satisfied.

11. The login system of claim 1, wherein the situational awareness processing unit extracts user information from the situation information to select a user extracted most frequently therefrom, identifies the selected user as a user of the situation information, and stores the situation information.

12. The login system of claim 1, wherein the situational awareness processing unit identifies a user nearest to the device as a user of the situation information and stores the situation information.

13. A situational awareness based login method comprising:
collecting situation information around a device;
identifying and storing a user from the collected situation information;
comparing the situation information and pre-stored device operation policy information and calculating a satisfaction rate; and
providing different login processes based on the calculated satisfaction rate.

14. The method of claim 13, wherein the collecting of the situation information around a device includes collecting the situation information within a preset situational awareness range.

15. The method of claim 13, wherein the calculating of the satisfaction rate includes comparing the situation information and the pre-stored device operation policy information and calculating the number of items which satisfy an item of the device operation policy information among items of the situation information as the satisfaction rate.

16. The method of claim 13, wherein the providing of the different login procedures includes providing login processes having different security grades according to an achieved satisfaction rate based on the satisfaction rate which is based on a comparison result of the situation information and the pre-stored device operation policy information.
